(19) United States
(12) Patent Application Publication
(10) Pub. No.: US 2015/0317962 A1
(43) Pub. Date: Nov. 5, 2015

(54) THROW OFF FOR A SNARE DRUM

(71) Applicant: Angel Drums LLC, Norton, MA (US)

(72) Inventors: Theodore MIHOS, Norton, MA (US); Robert HORVATH, Nagykallo (HU)

(21) Appl. No.: 14/615,474

(22) Filed: Feb. 6, 2015

Related U.S. Application Data
(60) Provisional application No. 61/936,668, filed on Feb. 6, 2014.

(51) Int. Cl. G10D 13/02

(52) U.S. Cl. CPC G10D 13/025

(57) ABSTRACT

This disclosure is directed to a snare drum throw off comprising a base component with a cylindrical opening through its vertical axis and an angled opening along its side that connects to the cylindrical opening and comprises a lip. The snare drum throw off also comprises a cylindrical component partially disposed inside the cylindrical opening of the base component. The throw off also comprises a handle connected to the cylindrical component and protruding through the angled opening of the base component. At the bottom of the cylindrical component is a snare attachment component. As a user turns the handle of the cylindrical component upwards along the angled opening, the cylindrical component is drawn through the base component, thereby pulling the snare attachment component towards the base component.

### PRIORITY

This application claims priority to U.S. Provisional Application No. 61/936,668, filed Feb. 6, 2014. The entire disclosure of that application is incorporated herein by reference.

### FIELD

This disclosure relates generally to musical instruments. In particular, this disclosure relates to percussion instruments.

### BACKGROUND

A snare drum is a type of drum with snares (also called “rattles” or “snare wires”) stretched across one or both drumheads. There are numerous types of snare drums, including, but not limited to, a marching snare, drum kit snare, piccolo snare, tabor snare, and a tarol snare. The snares are typically made of metal, gut, or synthetic material. The snares are typically stretched across the bottom drumhead on a drum.

Snare drums typically have a “butt plate” to anchor the snares on one side of the drum. The snares are stretched from the butt plate across the drumhead where they are held by a strainer mechanism. The strainer mechanism often includes a “throw off,” a mechanism for tightening the snares across the drumhead, thereby engaging them for use. When the top drumhead is struck, the bottom drumhead also vibrates, thereby stimulating the snares that are stretched across it.

The throw off can control the amount of tension on the snares and can also disengage the snares away from the drumhead when the snares are not in use.

### SUMMARY

This disclosure is directed to a novel snare drum throw off. One aspect of this disclosure is directed to a snare drum throw off comprising a base component comprising a cylindrical opening through vertical axis of the base component and an angled opening that connects to the cylindrical opening and twists around a portion of the base component at an angle between the horizontal and vertical axes of the base component. Along the bottom of the angled opening and near the higher end of the angled opening is an edge or a lip. The snare drum throw off also comprises a generally cylindrical component. A portion of the cylindrical component is disposed inside the cylindrical opening of the base component. The throw off also comprises a handle that is connected to the cylindrical component and protrudes through the angled opening. The handle allows a user to turn the cylindrical component while it is inside the cylindrical opening of the base component. The snare drum throw off also comprises a snare attachment component connected to the bottom of the cylindrical component. When a user moves the handle of the cylindrical component along the angled opening towards the lip, the cylindrical component rotates and is drawn through the cylindrical opening of the base component, and the snare attachment component is drawn towards the base component. When the handle moves over the lip in the angled opening of the base component, it becomes locked in position.

In some embodiments, a portion of the cylindrical component protrudes beyond the bottom of the base component. In some embodiments, a portion of the cylindrical component protrudes beyond the top of the base component. In some embodiments, portions of the cylindrical component protrude beyond the top and beyond the bottom of the base component.

In some embodiments, the cylindrical component comprises an opening through its vertical axis. In some embodiments, the snare drum throw off comprises a threaded rod or screw, wherein at least a portion of the threaded rod or screw is disposed inside the opening along the vertical axis of the cylindrical component, and wherein the threaded rod connects the cylindrical component to the snare drum attachment component. In some embodiments, the threaded rod protrudes through the top of the opening along the vertical axis of the cylindrical component. In some embodiments, the snare drum throw off further comprises a tuning knob connected to a portion of the threaded rod or screw.

In some embodiments, the snare attachment component comprises at least one snare attachment knob that can be used to clamp a snare or snare leader or can be used to tighten a clamp that holds a snare or snare leader. In some embodiments, the snare attachment component comprises a plurality of snare attachment knobs. In some embodiments, the snare attachment component comprises a spring-loaded clamp that keeps pressure on its jaw tips by a spring.

In some embodiments, the handle has a circular cross section. In some embodiments, diameter of the circular cross section of the handle varies over the length of the handle.

In some embodiments, the snare drum throw off further comprises an annular ring or wheel disposed around the handle.

### BRIEF DESCRIPTION OF THE FIGURES

FIG. 1 is a perspective view of an embodiment of the snare drum throw off of this disclosure.

FIG. 2 is a side view of an embodiment of the snare drum throw off of this disclosure.

FIGS. 3A & 3B are side views of an embodiment of the base component.

FIG. 4 is a perspective view of an embodiment of the snare attachment component of the snare drum throw off of this disclosure.

FIG. 5 is a side view of an embodiment of a threaded rod that can be used in the drum snare throw off

FIG. 6A is a perspective view of an embodiment of the tuning knob of the snare drum throw off. FIG. 6B is a side view of an embodiment of the tuning knob of the snare drum throw off.

FIG. 7A is a perspective view of an embodiment of a handle of the instant disclosure. FIG. 7B is a side view of an embodiment of a handle.

FIG. 8A is a view of the top of an embodiment of the throw off of this disclosure. FIG. 8B is a side view of the throw off of this disclosure. FIG. 8C is a view of the bottom of the throw off of this disclosure.

FIG. 9 is a perspective view of an embodiment of the snare drum throw off of the instance disclosure.

### DETAILED DESCRIPTION

This disclosure is directed to a snare drum throw off comprising a base component that comprises a cylindrical opening through its vertical axis and an angled opening on its side, wherein the angled opening twists around a portion of the base component at an angle that is between the horizontal and vertical axes of the base component and wherein the angled opening connects to the cylindrical opening. Near the higher end of the angled opening, the angle of the angled opening flattens towards the horizontal axis. Where the angle of the angled opening flattens, the angled opening comprises an edge or a lip. The edge or lip can be along the bottom of the angled opening. The edge or lip acts like a bump over which the handle can travel along the bottom of the angled opening.

The snare drum throw off also comprises a generally cylindrical component. At least a portion of the cylindrical component is disposed inside the cylindrical opening of the base component. The snare drum throw off also comprises a handle that is connected to the cylindrical component and protrudes through the angled opening of the base component. The handle allows a user to turn the cylindrical component while it is inside the cylindrical opening of the base component. The snare drum throw off also comprises a snare attachment component connected to the bottom of the cylindrical component. In some embodiments, the snare attachment component comprises at least one snare attachment knob. When a user moves the handle towards the top of the angled opening, the handle moves along the angled opening, thereby drawing the cylindrical component through the cylindrical opening of the base component and drawing the snare attachment component towards the base component.

When in use on a drum, drawing the snare attachment component towards the base component tightens snares attached to the snare attachment component across a drumhead. When the handle moves over the edge or lip in the angled opening of the base component, the position of the handle and the cylindrical component become locked in place and the position of the snare attachment component is maintained. When in use on a drum, when the handle is locked in place, the tension on the snares is maintained.

In some embodiments, the height of the cylindrical component is greater than the height of the base component. In some embodiments, the height of the cylindrical component is less than the height of the base component.

The handle can have a variety of shapes. In some embodiments, the handle is generally cylindrical. In some embodiments, the handle is generally conical. In some embodiments, the handle has a generally uniform thickness. In some embodiments, the handle has a varying or tapering thickness. In some embodiments, the handle has a circular cross-section. In some embodiments, the handle has an oval or elliptical cross-section. In some embodiments, the handle has a rectangular cross-section. In other embodiments, the handle has a triangular cross section. In some embodiments, the handle has a pentagonal cross-section. In other embodiments, the handle has a hexagonal cross-section. In other embodiments, the handle has a cross-section with greater than six sides. In some embodiments, the handle has a cross-shaped cross-section. In some embodiments, the handle has a cross-section that is different at one end than the other. In some embodiments, the handle is larger at one end than at the other. In some embodiments, the handle has a circular cross-section with a diameter that varies over the length of the handle.

The handle can connect to the cylindrical component in numerous ways. In some embodiments, the handle is threaded into the cylindrical component. In some embodiments, the handle is welded or soldered onto the cylindrical component. In some embodiments, the handle is attached to the cylindrical component by liquid cement or glue. In other embodiments, the handle is connected to the cylindrical component by a connector. In some embodiments, the handle is connected to the cylindrical component by a bushing. In other embodiments, the handle is connected to the cylindrical component by a coupling. Further ways of connecting the handle to the cylindrical component which those skilled in the art will recognize, or be able to ascertain through no more than routine experimentation, are intended to be encompassed within the scope of this disclosure. As used herein, the term “handle” refers to both a handle the connects directly to a cylindrical component and to a handle that connects to a cylindrical component using one or more connectors.

In some embodiments, the handle comprises an annular ring or wheel that goes around the handle, or around a connector, and is disposed within the angled opening. When the handle is moved through the angled opening, a portion of the annular ring or wheel contacts the side walls of the angled opening, and the annular ring or wheel rolls along the angled opening, thereby allowing for smoother turning of the handle and the cylindrical component.

In some embodiments, the snare attachment component is connected directly to the cylindrical component. In some embodiments, the snare attachment component is connected to the cylindrical component via a connector that is welded, soldered, glued, or cemented to the cylindrical component, the snare attachment component, or both.

In some embodiments, the snare attachment component is connected to the cylindrical component by a threaded rod or screw that is disposed in an opening through the vertical axis of the cylindrical component. In some embodiments, the threaded rod or screw also protrudes through the opening at the top of the cylindrical component. In such embodiments, one end of the threaded rod or screw connects to the snare attachment component and the other end protrudes through the top of the cylindrical component. In some embodiments, a tuning knob is connected to the end of the threaded rod or screw that protrudes through the top of the cylindrical component.

The threaded rod or screw allows a user to tune the tension on the snare. When a user turns the threaded rod or screw, or a knob connected to the top of the threaded rod or screw, the threaded rod or screw can thread further into the snare attachment component, thereby drawing the snare attachment component closer to the base component and further tightening any attached snares, or can thread out of the snare attachment component, thereby moving the snare attachment component away from the base component and relaxing the tension on the snares. Furthermore, in some embodiments, turning the knob connected to the top of the threaded rod or screw can cause the threaded rod or screw to thread into or out of the knob, thereby drawing the snare attachment component towards or away from the base component.

In some embodiments, the threaded rod or screw only has threads at one end. In such embodiments, the threaded rod can be used to either thread into the snare attachment component or a knob on top.

The threaded rod or screw do not increase or decrease the tension so much that the snares can be engaged or disengaged. However, once the cylindrical component is locked in place in the base component, moving the threaded rod or screw allows the user to make further fine adjustments to the tension of the snare, thereby allowing for more precise tuning and allowing a user to more precisely choose a desired snare sound.

In some embodiments, the snare drum throw off comprises a tuning knob locking mechanism for holding the tuning knob in place so that the vibration of the drum during use does not cause the tuning knob to turn, thereby loosening the snares. In some embodiments, the tuning knob locking mechanism comprises a ball bearing. In some embodiments, the base component comprises the tuning knob locking mechanism. In some embodiments, the tuning knob locking mechanism comprises a ball bearing. In such embodiments, the tuning knob has at least one indentation capable of receiving a portion of the ball bearing in its bottom. When the ball bearing fits into the indentation, the tuning knob is held in place.

In some embodiments, the cylindrical component comprises the tuning knob locking mechanism. In some embodiments, the tuning knob locking mechanism comprises a ball bearing. In such embodiments, the tuning knob has at least one indentation capable of receiving a portion of the ball bearing in its bottom. When the ball bearing fits into the indentation, the tuning knob is held in place.

In some embodiments, the tuning knob has a plurality of indentations capable of receiving a portion of the tuning knob locking mechanism to provide a variety of tuning positions to the user. In some embodiments, a small hole is drilled into the base component or the cylindrical component, and a ball bearing is hammered into the hole. In some embodiments, the ball bearing is spring loaded, so that it can recede into a hole on the cylindrical component or base component when depressed. In such embodiments, when the ball bearing fits into an indentation on the bottom of the tuning knob, the spring maintains upward pressure on the ball bearing, thereby pushing it into the indentation on the bottom of the tuning knob and helping maintain the position of the tuning knob.

The tuning knob locking mechanism need not be limited to a ball bearing. In other embodiments, the tuning knob locking mechanism is a tab, tooth, or other protrusion sticking up from the base component or the cylindrical component. In such embodiments, the tuning knob comprises at least one corresponding indentation capable of receiving a portion of the tab, tooth, or other protrusion on its bottom. In some embodiments, the tuning knob locking mechanism is spring loaded. In some embodiments, the tuning knob has a plurality of indentations capable of receiving the tuning knob locking mechanism.

In some embodiments, the snare drum attachment component comprises a clamp for holding the snare wires or snare leader. In some embodiments, the snare drum attachment component comprises a knob for tightening the clamp. In some embodiments, the snare attachment component has a plurality of knobs for tightening the clamp. In some embodiments, the clamp maintains pressure nears its jaw tips with a spring. In some embodiments, the snare attachment component comprises one or more knobs to which the snare wires attach directly. In such embodiments, turning the knob tightens the snare wires.

The snare drum throw off of this disclosure can be made of metal, titanium, nickel, tungsten carbide, metal alloy, wood, brass, bell brass, bell bronze, bronze, aluminum, steel, alloys of steel, stainless steel, carbon steel, and alloys of iron and zinc. In some embodiments, the snare drum throw off is manufactured by machining In some embodiments, the snare drum throw off is manufactured by casting with pot metal.

The snare drum throw off of this disclosure can be used on new drums and existing drums. When attached to a drum, the snare drum throw off is attached to the drum shell opposite of the butt plate so that it holds the snares across the drumhead. In some embodiments, the drum snare throw off is attached to the drum shell through holes in the drum shell by bolts and spacers on the outside of the base component. In some embodiments, the snare drum throw off is mounted with an adapter plate to fit existing snare drums.

In some embodiments, the snare drum throw off is used on drums having diameters ranging from about 6″ to about 18″. In some embodiments, the snare drum throw off is used on drums ranging from 3″ to about 20″ deep. In the context of inches, the term “about” means plus or minus ½ an inch.

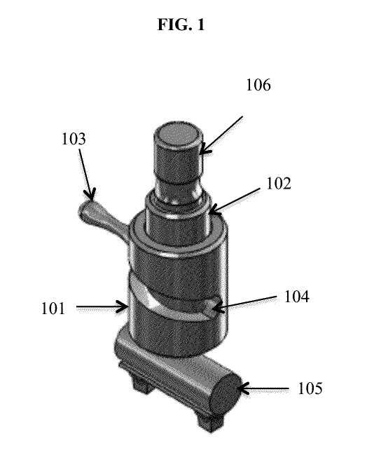

FIG. 1 is a perspective view of an embodiment of the snare drum throw off. A portion of cylindrical component 102 is disposed inside base component 101. Handle 103 protrudes through angled opening 104 of base component 101. Snare attachment component 105 is connected to the bottom of cylindrical component 102 by a threaded rod (not visible in FIG. 1). Tuning knob 106 is attached to the top of the threaded rod.

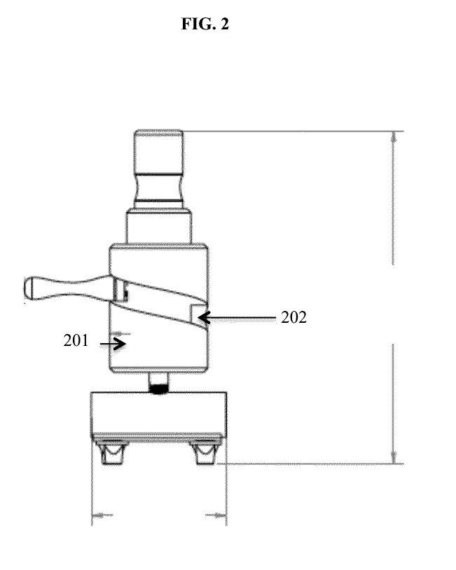

FIG. 2 shows a side view of angled opening 202 of base component 201. Angled opening 202 twists around a portion of base component 201 at an angle between the horizontal and vertical axes of base component 201.

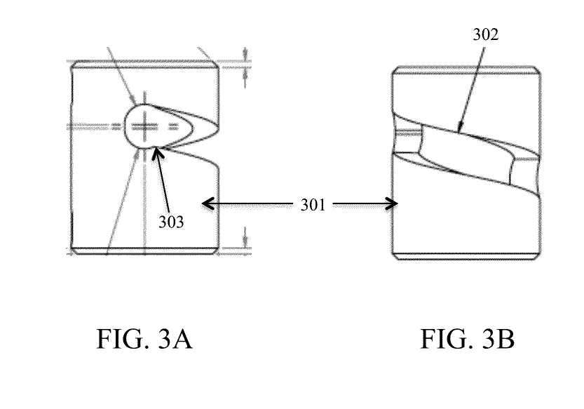

FIGS. 3A and 3B show side views of base component 301. Angled opening 302 twists around a portion of base component 301. Lip 303 is near the top of angled opening 302.

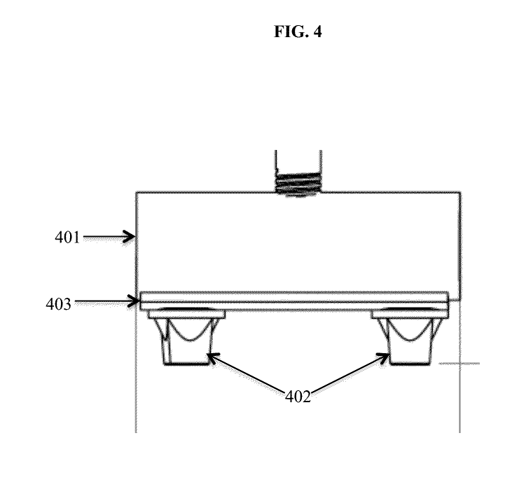

FIG. 4 shows an embodiment of the snare attachment component of the snare drum throw off. Snare attachment component 401 comprises knobs 402 for tightening clamp 403, which holds the snare wires or the snare leader.

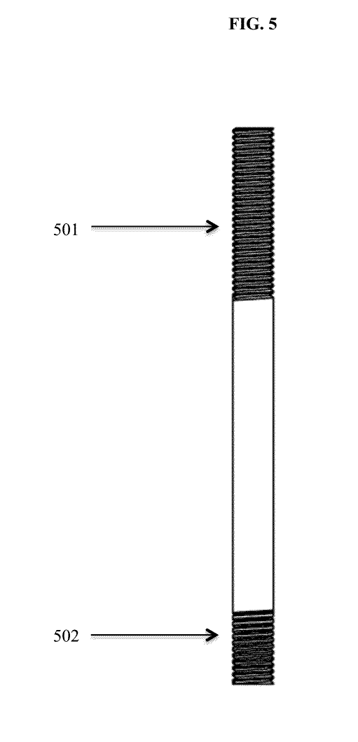

FIG. 5 shows an embodiment of a threaded rod that can be used with the throw off of the instant disclosure. The threaded rod of FIG. 5 has threads 501 and 502 at both ends. In some embodiments, one thread is for connecting to a tuning knob and the other thread is for connecting to a snare attachment component.

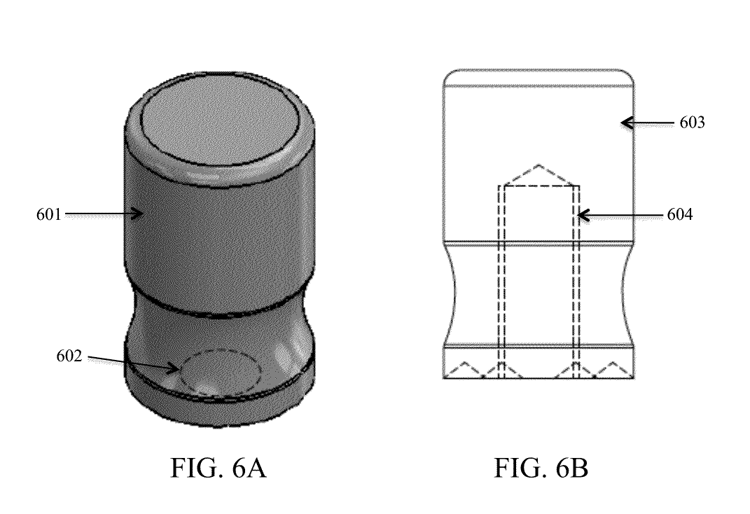

FIG. 6A shows an embodiment of tuning knob. Tuning knob 601 comprises opening 602 (shown in phantom) for receiving a connecting rod. Tuning knob 603 of FIG. 6B shows connecting rod 604 (shown in phantom) inside and connected to tuning knob 603. Turning tuning knob 601 or 603 can actuate a connected threaded rod or screw to thread into or out of a snare attachment component, or actuate a threaded rod or screw to thread into or out of tuning knob 601 or 603, or can actuate both.

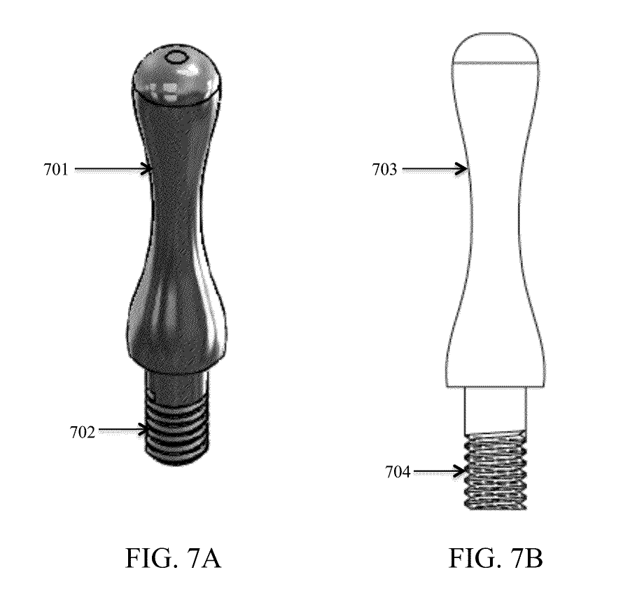

FIG. 7A shows an embodiment of the handle. Handle 701 comprises threads 702 for connecting to a cylindrical component (not shown). Handle 701 can thread into a threaded opening on a cylindrical component. FIG. 7B shows a side view of a similar embodiment of the handle. Handle 703 comprises threads 704 for connecting to a cylindrical component. Handle 703 can thread into a threaded opening on the cylindrical component.

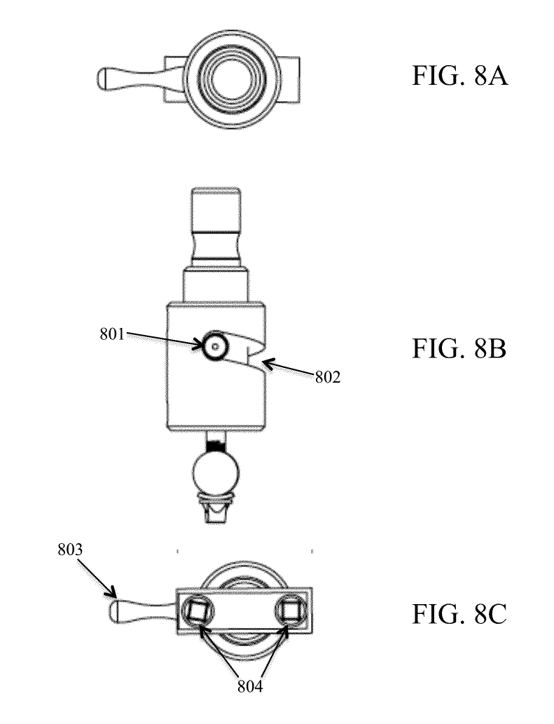

FIG. 8A shows a view of the top of the throw off of this disclosure. FIG. 8B shows a side view of the throw off. Handle 801 is shown at the top of angled opening 802. FIG. 8C is a view of the bottom of the throw off. Handle 803 is visible as well as knobs 804 for the snare attachment component.

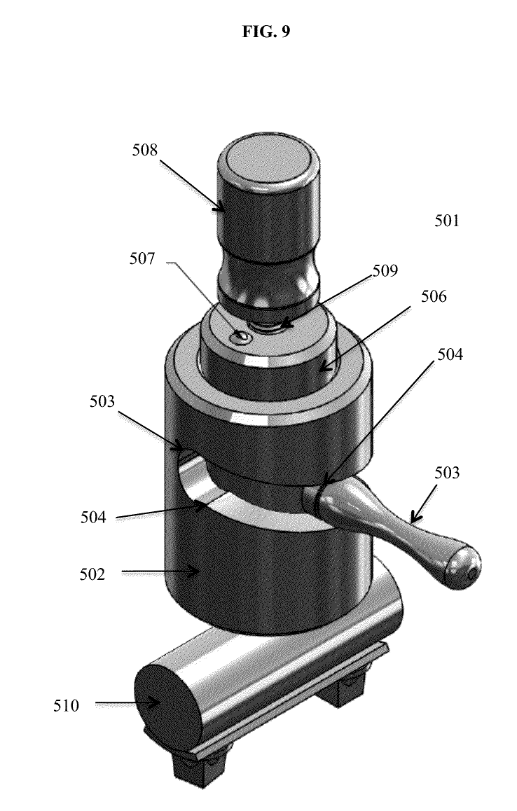

FIG. 9 shows a perspective view of an embodiment of the snare drum throw off of this disclosure. Snare drum throw off 501 comprises base component 502. Base component 502 comprises angled opening 503. Lip 504 is along the bottom of angled opening 503 and near the higher end of angled opening 503. Cylindrical component 505 is disposed inside a cylindrical opening of base component 502. Cylindrical component 505 comprises ball bearing 506, which is capable of fitting into an indentation (not shown in FIG. 9) in the bottom of tuning knob 507. Tuning knob 507 is connected to threaded rod 508, which is disposed inside a vertical opening in cylindrical component 505. At its other end, threaded rod 508 is connected to snare attachment component 509. Snare drum throw off 501 also comprises handle 510, which comprises annular ring 511 for smoother movement through angled opening 503.

### Equivalents

Those skilled in the art will recognize, or be able to ascertain, using no more than routine experimentation, numerous equivalents to the specific embodiments described specifically in this disclosure. Such equivalents are intended to be encompassed in the scope of the following claims.

1. A snare drum throw off comprising:
a base component comprising
a cylindrical opening through the vertical axis of the base component,
an angled opening that twists around a portion of the base component at an angle between the horizontal and vertical axes of the base component, and connects to the cylindrical opening, and
a lip along the bottom of the angled opening;
a cylindrical component, wherein at least a portion of the cylindrical component is disposed inside the cylindrical opening of the base component;
a handle connected to the cylindrical component and protruding through the angled opening of the base component;
a snare attachment component connected to the bottom of the cylindrical component.

2. The snare drum throw off of claim 1, wherein the snare attachment component comprises at least one snare attachment knob.

3. The snare drum throw off of claim 2, wherein the snare attachment component comprises a plurality of snare attachment knobs.

4. The snare drum throw off of claim 1, wherein the cylindrical component comprises an opening through its vertical axis.

5. The snare drum throw off of claim 4, further comprising a threaded rod,
wherein at least a portion of the threaded rod is disposed inside the opening along the vertical axis of the cylindrical component, and
wherein the threaded rod connects the cylindrical component to the snare drum attachment component.

6. The snare drum throw off of claim 5, wherein the threaded rod protrudes through the top of the opening along the vertical axis of the cylindrical component.

7. The snare drum throw off of claim 6, further comprising a tuning knob connected to the top of the threaded rod.

8. The snare drum throw off of claim 7, further comprising a tuning knob locking mechanism.

9. The snare drum throw off of claim 11, wherein the base component comprises the tuning knob locking mechanism.

10. The snare drum throw off of claim 12, wherein the tuning knob locking mechanism comprises a ball bearing.

11. The snare drum throw off of claim 11, wherein the cylindrical component comprises the tuning knob locking mechanism.

12. The snare drum throw off of claim 14, wherein the tuning knob locking mechanism comprises a ball bearing.

13. The snare drum throw off of claim 1, wherein the handle has a circular cross-section.

14. The snare drum throw off of claim 13, wherein the diameter of the circular cross-section of the handle varies over the length of the handle.

15. The snare drum throw off of claim 1, further comprising an annular ring or wheel disposed around the handle.
